(19) United States
(12) Patent Application Publication
(10) Pub. No.: US 2024/0163282 A1
(43) Pub. Date: May 16, 2024

(54) PLUGGABLE TRUSTED PLATFORM MODULE REMOTE ATTESTATION

(71) Applicant: ARRIS Enterprises LLC, Suwanee, GA (US)

(72) Inventor: Cheng-Ming Chien, Taipei (TW)

(73) Assignee: ARRIS Enterprises LLC, Suwanee, GA (US)

(21) Appl. No.: 18/508,313

(22) Filed: Nov. 14, 2023

Related U.S. Application Data
(60) Provisional application No. 63/425,324, filed on Nov. 15, 2022.

(51) Int. Cl. H04L 9/40; G06F 21/10

(52) U.S. Cl. CPC H04L 63/0853; G06F 21/1011; G06F 21/107; H04L 63/0823; H04L 63/0869

(57) ABSTRACT

A computer system may receive, from a second electronic device, provisioning information for the electronic device and may confirm a license associated with the electronic device based at least in part on the provisioning information. Moreover, the computer system may receive, from the electronic device, confirmation information and may perform a join flow with the electronic device based at least in part on the confirmation information. Then, the computer system may provide, to the electronic device, authorization information. When the electronic device includes an instance of a trusted platform module (TPM) chip, prior to performing the join flow, the computer system may: provide, to the electronic device, an attestor identity key (AIK) certificate; perform remote attestation with the electronic device based at least in part on the AIK certificate; and verify the electronic device based at least in part on a result of the remote attestation.

### CROSS REFERENCE TO RELATED APPLICATIONS

This application claims priority under 35 U.S.C. 119(e) to U.S. Provisional Application Ser. No. 63/425,324, “Pluggable Trusted Platform Module Remote Attestation,” filed on Nov. 15, 2022, by Cheng-Ming Chien, the contents of which are herein incorporated by reference.

### FIELD

The described embodiments relate to techniques for dynamically enabling trusted platform module (TPM) capability in electronic devices for enhanced security via TPM attestation.

### BACKGROUND

Many electronic devices are capable of wirelessly communicating with other electronic devices. For example, these electronic devices can include a networking subsystem that implements a network interface for: a cellular network (UMTS, LTE, etc.), a wireless local area network or WLAN (e.g., a wireless network such as described in the Institute of Electrical and Electronics Engineers (IEEE) 802.11 standard or Bluetooth™ from the Bluetooth Special Interest Group of Kirkland, Washington), and/or another type of wireless network.

In order to enhance security of a network, some electronic devices (such as access points) include instances of a TPM chip to confirm the identities of these electronic devices and to prove that they are trustworthy. This authentication process is performed before the electronic devices are allowed to connect to the network. Alternatively, other electronic devices do not include instances of the TPM chip. Instead, these electronic devices may use a virtualized solution to confirm their identifies and to prove that they are trustworthy before the electronic devices are allowed to connect to a network. However, the virtualized solution is often prohibitively expensive. Consequently, there is a need for a technique to authenticate an electronic device, which may or may not include an instance of a TPM chip, before the electronic device is allowed to connect to a network.

### SUMMARY

In a first group of embodiments, a computer system that performs remote attestation is described. This computer system includes: an interface circuit that communicates with an electronic device; a processor; and memory that stores program instructions. During operation, when the electronic device includes or does not include an instance of a TPM chip, the computer system performs a set of operations. Notably, the computer system receives, associated with a second electronic device, provisioning information for the electronic device. Then, the computer system confirms a license associated with the electronic device based at least in part on the provisioning information. Moreover, the computer system receives, associated with the electronic device, confirmation information (such as a manufacturer certificate) and performs a join flow with the electronic device based at least in part on the confirmation information, where the join flow establishes a connection between the electronic device and the computer system. Next, the computer system provides, addressed to the electronic device, authorization information.

Note that confirming the license may include confirming that the electronic device is associated with a customer.

Moreover, the join flow may include performing mutual authentication with the electronic device. For example, the mutual authentication may include Mutual Transport Layer Security (mTLS).

Furthermore, the authorization information may include a JavaScript Object Notation (JSON) Web Token (JWT).

In some embodiments, the electronic device includes the instance of the TPM chip. (However, in other embodiments, the electronic device may not include the instance of the TPM chip.) In these embodiments, the provisioning information may include an identifier associated with the instance of the TPM chip in the electronic device. For example, the identifier may include a serial number of the instance of the TPM chip. Moreover, the license may be associated with the instance of the TPM chip. Furthermore, prior to performing the join flow, the computer system may: provide, addressed to the electronic device, an attestor identity key (AIK) certificate; sign the AIK certificate; and perform the remote attestation with the electronic device based at least in part on the AIK certificate, where the remote attestation includes TPM attestation. Additionally, the confirmation information may include the AIK certificate. Next, the computer system may perform verification of the electronic device based at least in part on the identifier and a result of the TPM attestation. When the verification is successful, the computer system may provide the authorization information.

Note that the AIK certificate may be associated with a TPM verifier in the computer system, and the TPM verifier may perform the TPM attestation with a TPM attestor in the electronic device. In some embodiments, the AIK certificate may be signed by a privacy certificate authority (CA) in the computer system.

Moreover, the computer system may periodically perform the TPM attestation with the electronic device.

Another embodiment provides the electronic device, which perform counterparts to at least some of the aforementioned operations.

Another embodiment provides a computer-readable storage medium for use with the electronic device or the computer system. This computer-readable storage medium may include program instructions that, when executed by the electronic device or the computer system, cause the electronic device or the computer system to perform at least some of the aforementioned operations or counterparts to at least some of the aforementioned operations.

Another embodiment provides a method. This method includes at least some of the operations performed by the computer system or counterparts to at least some of the aforementioned operations.

In a second group of embodiments, a computer system that performs remote software and/or or configuration-file verification is described. This computer system includes: an interface circuit that communicates with an electronic device; a processor; and memory that stores program instructions. During operation, the computer system receives, associated with the electronic device, a hash code associated with software and/or a configuration file installed on the electronic device. Then, the computer system verifies the software and/or the configuration file based at least in part on the hash code. Moreover, the computer system provides, addressed to the electronic device, an instance of a dynamic question associated with the software, the configuration file and/or a process executed by the electronic device. Next, the computer system receives, associated with the electronic device, a second hash code in response to the instance of the dynamic question. Furthermore, the computer system verifies the software and/or the configuration file based at least in part on the second hash code.

Note that the instance of the dynamic question may be provided when the computer system performs TPM attestation with the electronic device.

Moreover, the electronic device may or may not include an instance of a TPM chip.

Furthermore, instances of the dynamic question may be provided periodically.

Additionally, the software may include a software binary.

In some embodiments, the instance of the dynamic question is varied as a function of time. For example, the instance of the dynamic question may be randomly selected from a set of predefined questions.

Note that the second hash code may be computed by the electronic device at runtime of the software or the process.

Moreover, the instance of the dynamic question may include or may specify a hash function that is to be used by the electronic device to generate the second hash code. Alternatively or additionally, prior to providing the instance of the dynamic question, the computer system may provide, addressed to the electronic device, the hash function.

Furthermore, the instance of the dynamic question may include: which process uses most resources in the electronic device, a request for a list of processes executed by the electronic device, etc.

Another embodiment provides the electronic device, which perform counterparts to at least some of the aforementioned operations.

Another embodiment provides a computer-readable storage medium for use with the electronic device or the computer system. This computer-readable storage medium may include program instructions that, when executed by the electronic device or the computer system, cause the electronic device or the computer system to perform at least some of the aforementioned operations or counterparts to at least some of the aforementioned operations.

Another embodiment provides a method. This method includes at least some of the operations performed by the computer system or counterparts to at least some of the aforementioned operations.

This Summary is provided for purposes of illustrating some exemplary embodiments, so as to provide a basic understanding of some aspects of the subject matter described herein. Accordingly, it will be appreciated that the above-described features are examples and should not be construed to narrow the scope or spirit of the subject matter described herein in any way. Other features, aspects, and advantages of the subject matter described herein will become apparent from the following Detailed Description, Figures, and Claims.

### BRIEF DESCRIPTION OF THE FIGURES

FIG. 1 is a block diagram illustrating an example of a system in accordance with an embodiment of the present disclosure.

FIG. 2 is a flow diagram illustrating an example method for performing remote attestation using an electronic device in FIG. 1 in accordance with an embodiment of the present disclosure.

FIG. 3 is a drawing illustrating an example of communication among electronic devices in FIG. 1 in accordance with an embodiment of the present disclosure.

FIG. 4 is a drawing illustrating an example of communication among electronic devices in FIG. 1 in accordance with an embodiment of the present disclosure.

FIG. 5 is a flow diagram illustrating an example method for performing remote software and/or configuration-file verification using an electronic device in FIG. 1 in accordance with an embodiment of the present disclosure.

FIG. 6 is a drawing illustrating an example of communication among electronic devices in FIG. 1 in accordance with an embodiment of the present disclosure.

FIG. 7 is a flow diagram illustrating an example method for performing remote software and/or configuration-file verification using a computer system in FIG. 1 in accordance with an embodiment of the present disclosure.

FIG. 8 is a block diagram illustrating an example of an electronic device in accordance with an embodiment of the present disclosure.

Note that like reference numerals refer to corresponding parts throughout the drawings. Moreover, multiple instances of the same part are designated by a common prefix separated from an instance number by a dash.

### DETAILED DESCRIPTION

In a first group of embodiments, a computer system that performs remote attestation is described. During operation, when the electronic device includes or does not include an instance of a TPM chip, the computer system may perform a set of operations. Notably, the computer system may receive, from a second electronic device, provisioning information for the electronic device. Then, the computer system may confirm a license associated with the electronic device based at least in part on the provisioning information. Moreover, the computer system may receive, from the electronic device, confirmation information (such as a manufacturer certificate) and may perform a join flow with the electronic device based at least in part on the confirmation information, where the join flow establishes a connection between the electronic device and the computer system. Next, the computer system may provide, to the electronic device, authorization information.

When the electronic device includes the instance of the TPM chip, prior to performing the join flow, the computer system may: provide, to the electronic device, an attestor identity key (AIK) certificate; sign the AIK certificate; and perform the remote attestation with the electronic device based at least in part on the AIK certificate. Additionally, the confirmation information may include the AIK certificate. Next, the computer system may perform verification of the electronic device based at least in part on the identifier and a result of the TPM attestation. When the verification is successful, the computer system may provide the authorization information.

By authorizing the second electronic device, these authentication techniques may help confirm the identity of the electronic device and prove that the electronic device is trustworthy. For example, when the electronic device is an access point, the authentication techniques may help ensure that the electronic device is provided by a manufacturer and is intended to be included in a network. In these ways, the authentication techniques may help prevent rogue access points from joining the network. Consequently, the authentication techniques may enhance security of the network and, thus, may provide an improved user experience.

In a second group of embodiments, a computer system that performs remote software and/or configuration-file verification is described. During operation, the computer system may receive, from the electronic device, a hash code associated with software and/or a configuration file installed on the electronic device. Then, the computer system may verify the software and/or the configuration file based at least in part on the hash code. Moreover, the computer system may provide, to the electronic device, an instance of a dynamic question associated with the software, the configuration file and/or a process executed by the electronic device. Next, the computer system may receive, from the electronic device, a second hash code in response to the instance of the dynamic question. Furthermore, the computer system may verify the software and/or the configuration file based at least in part on the second hash code.

By verifying the software and/or the configuration file, these verification techniques may help ensure that the software and/or the configuration file are unchanged or match a deployed instance of the software and/or the configuration file. This may help prevent stolen or malicious code from being installed and used by the electronic device. Consequently, the verification techniques may enhance security of a network that includes the electronic device and, thus, may provide an improved user experience.

In the discussion that follows, electronic devices or components in a system communicate packets in accordance with a wireless communication protocol, such as: a wireless communication protocol that is compatible with an IEEE 802.11 standard (which is sometimes referred to as ‘Wi-Fi®,’ from the Wi-Fi Alliance of Austin, Texas), Bluetooth, a cellular-telephone network or data network communication protocol (such as a third generation or 3G communication protocol, a fourth generation or 4G communication protocol, e.g., Long Term Evolution or LTE (from the 3rd Generation Partnership Project of Sophia Antipolis, Valbonne, France), LTE Advanced or LTE-A, a fifth generation or 5G communication protocol, or other present or future developed advanced cellular communication protocol), and/or another type of wireless interface (such as another wireless-local-area-network interface). For example, an IEEE 802.11 standard may include one or more of: IEEE 802.11a, IEEE 802.11b, IEEE 802.11g, IEEE 802.11-2007, IEEE 802.11n, IEEE 802.11-2012, IEEE 802.11-2016, IEEE 802.11ac, IEEE 802.11ax, IEEE 802.11ba, IEEE 802.11be, or other present or future developed IEEE 802.11 technologies. Moreover, an access point, a radio node, a base station or a switch in the wireless network may communicate with a local or remotely located computer (such as a controller) using a wired communication protocol, such as a wired communication protocol that is compatible with an IEEE 802.3 standard (which is sometimes referred to as ‘Ethernet’), e.g., an Ethernet II standard. However, a wide variety of communication protocols may be used in the system, including wired and/or wireless communication. In the discussion that follows, Wi-Fi, LTE and Ethernet are used as illustrative examples.

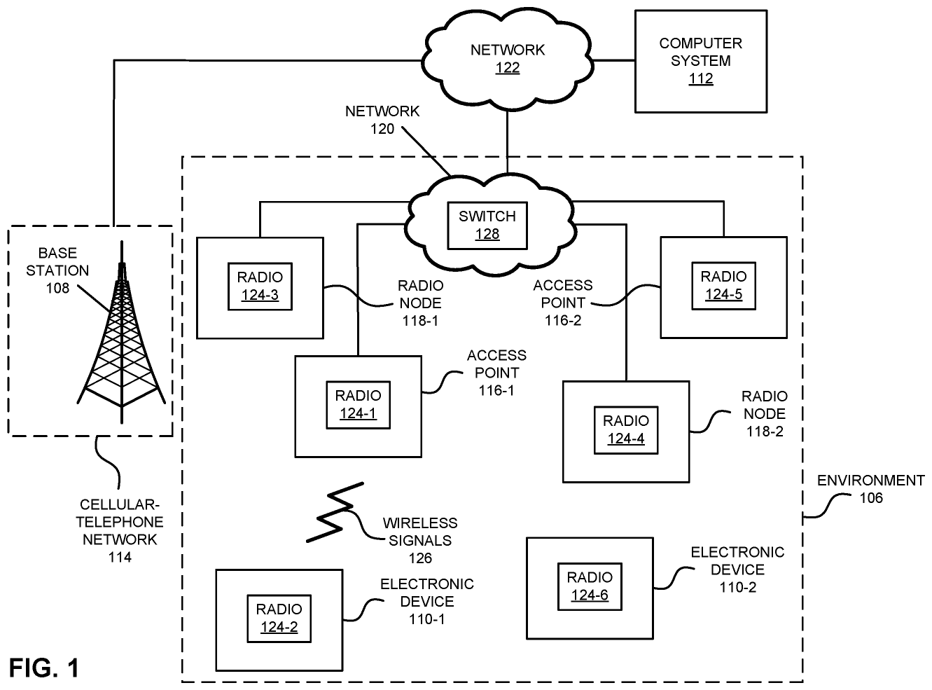

We now describe some embodiments of the authentication and the verification techniques. FIG. 1 presents a block diagram illustrating an example of communication in an environment 106 with one or more electronic devices 110 (such as cellular telephones, portable electronic devices, stations or clients, another type of electronic device, etc.) via a cellular-telephone network 114 (which may include a base station 108), one or more access points 116 (which may communicate using Wi-Fi) in a WLAN and/or one or more radio nodes 118 (which may communicate using LTE) in a small-scale network (such as a small cell). For example, the one or more radio nodes 118 may include: an Evolved Node B (eNodeB), a Universal Mobile Telecommunications System (UMTS) NodeB and radio network controller (RNC), a New Radio (NR) gNB or gNodeB (which communicates with a network with a cellular-telephone communication protocol that is other than LTE), etc. In the discussion that follows, an access point, a radio node or a base station are sometimes referred to generically as a ‘communication device.’ Moreover, as noted previously, one or more base stations (such as base station 108), access points 116, and/or radio nodes 118 may be included in one or more wireless networks, such as: a WLAN, a small cell, and/or a cellular-telephone network. In some embodiments, access points 116 may include a physical access point and/or a virtual access point that is implemented in software in an environment of an electronic device or a computer.

Note that access points 116 and/or radio nodes 118 may communicate with each other and/or computer system 112 (which may include one or more computers, and which may be a local or cloud-based controller that manages and/or configures access points 116, radio nodes 118 and/or switch 128, or a cloud-based computer system that provides cloud-based storage and/or analytical services) using a wired communication protocol (such as Ethernet) via network 120 and/or 122. Note that networks 120 and 122 may be the same or different networks. For example, networks 120 and/or 122 may an LAN, an intra-net or the Internet. In some embodiments, network 120 may include one or more routers and/or switches (such as switch 128).

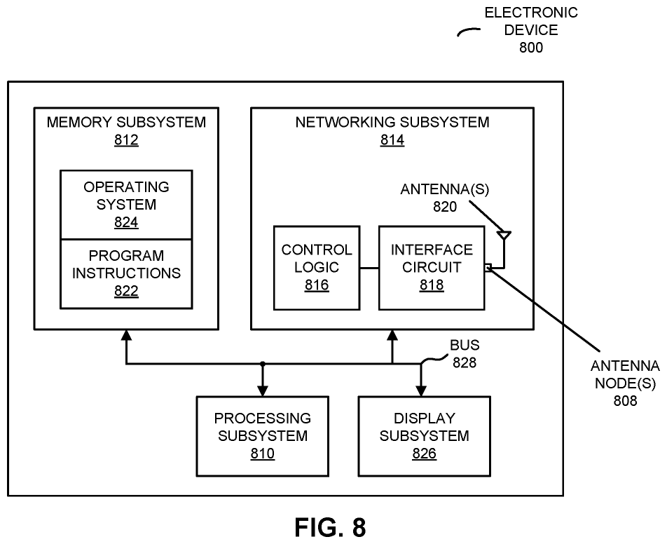

As described further below with reference to FIG. 8, electronic devices 110, computer system 112, access points 116, radio nodes 118 and switch 128 may include subsystems, such as a networking subsystem, a memory subsystem and a processor subsystem. In addition, electronic devices 110, access points 116 and radio nodes 118 may include radios 124 in the networking subsystems. More generally, electronic devices 110, access points 116 and radio nodes 118 can include (or can be included within) any electronic devices with the networking subsystems that enable electronic devices 110, access points 116 and radio nodes 118 to wirelessly communicate with one or more other electronic devices. This wireless communication can comprise transmitting access on wireless channels to enable electronic devices to make initial contact with or detect each other, followed by exchanging subsequent data/management frames (such as connection requests and responses) to establish a connection, configure security options, transmit and receive frames or packets via the connection, etc.

During the communication in FIG. 1, access points 116 and/or radio nodes 118 and electronic devices 110 may wired or wirelessly communicate while: transmitting access requests and receiving access responses on wireless channels, detecting one another by scanning wireless channels, establishing connections (for example, by transmitting connection requests and receiving connection responses), and/or transmitting and receiving frames or packets (which may include information as payloads).

As can be seen in FIG. 1, wireless signals 126 (represented by a jagged line) may be transmitted by radios 124 in, e.g., access points 116 and/or radio nodes 118 and electronic devices 110. For example, radio 124-1 in access point 116-1 may transmit information (such as one or more packets or frames) using wireless signals 126. These wireless signals are received by radios 124 in one or more other electronic devices (such as radio 124-2 in electronic device 110-1). This may allow access point 116-1 to communicate information to other access points 116 and/or electronic device 110-1. Note that wireless signals 126 may convey one or more packets or frames.

In the described embodiments, processing a packet or a frame in access points 116 and/or radio nodes 118 and electronic devices 110 may include: receiving the wireless signals with the packet or the frame; decoding/extracting the packet or the frame from the received wireless signals to acquire the packet or the frame; and processing the packet or the frame to determine information contained in the payload of the packet or the frame.

Note that the wireless communication in FIG. 1 may be characterized by a variety of performance metrics, such as: a data rate for successful communication (which is sometimes referred to as ‘throughput’), an error rate (such as a retry or resend rate), a mean-square error of equalized signals relative to an equalization target, intersymbol interference, multipath interference, a signal-to-noise ratio, a width of an eye pattern, a ratio of number of bytes successfully communicated during a time interval (such as 1-10 s) to an estimated maximum number of bytes that can be communicated in the time interval (the latter of which is sometimes referred to as the ‘capacity’ of a communication channel or link), and/or a ratio of an actual data rate to an estimated data rate (which is sometimes referred to as ‘utilization’). While instances of radios 124 are shown in components in FIG. 1, one or more of these instances may be different from the other instances of radios 124.

In some embodiments, wireless communication between components in FIG. 1 uses one or more bands of frequencies, such as: 900 MHz, 2.4 GHz, 5 GHz, 6 GHz, 7 GHz, 60 GHz, the Citizens Broadband Radio Spectrum or CBRS (e.g., a frequency band near 3.5 GHz), and/or a band of frequencies used by LTE or another cellular-telephone communication protocol or a data communication protocol. Note that the communication between electronic devices may use multi-user transmission (such as orthogonal frequency division multiple access or OFDMA) and/or multiple input, multiple output (MIMO).

Although we describe the network environment shown in FIG. 1 as an example, in alternative embodiments, different numbers or types of electronic devices may be present. For example, some embodiments comprise more or fewer electronic devices. As another example, in another embodiment, different electronic devices are transmitting and/or receiving packets or frames.

As discussed previously, while some computer network devices (such as some of access points 116, radio nodes 118, switch 128, a data plane, a control plane, a software-defined WLAN and/or an edge device) may include instances of TPM chips, other computer network devices may not include instances of TPM chips. (In addition, a controller may include an instance of a TPM chip.) In some embodiments, an instance of a TPM chip may store a private key pair. However, the variation in whether or not computer network devices include instances of TPM chips may make it difficult to have a common remote-attestation procedure for the computer network devices, which may adversely impact security in a network that includes the computer network devices.

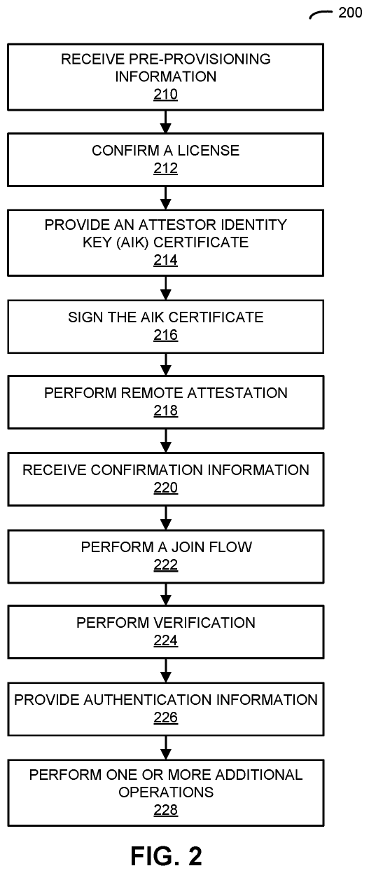

As described below with reference to FIGS. 2-4, in order to address this problem, a computer system (such as computer system 112) may perform remote attestation. During operation, when an electronic device (such as access point 116-1) does not include an instance of a TPM chip, computer system 112 may receive, from another electronic device (such as electronic device 110-1), provisioning information for access point 116-1. Then, computer system 112 may confirm a license associated with access point 116-1 based at least in part on the provisioning information. For example, confirming the license may include confirming that access point 116-1 is associated with a customer, such as of a provider or manufacturer of access point 116-1, or of a network. Moreover, computer system 112 may receive, from access point 116-1, confirmation information (such as a manufacturer certification of access point 116-1) and may perform a join flow with access point 116-1 based at least in part on the confirmation information, where the join flow establishes a connection between access point 116-1 and computer system 112. Note that the join flow may include performing mutual authentication with access point 116-1, such as by using or performing mTLS. Next, computer system 112 may provide, to access point 116-1, authorization information (such as a JWT).

Alternatively, during operation, when access point 116-1 includes the instance of the TPM chip, computer system 112 may receive, from another electronic device (such as electronic device 110-1), provisioning information for access point 116-1, which may include an identifier (such as a serial number) associated with the instance of the TPM chip. Then, computer system 112 may confirm a license associated with access point 116-1 based at least in part on the provisioning information. For example, the license may be associated with the instance of the TPM chip. Moreover, computer system 112 may: provide, to access point 116-1, an AIK certificate; sign the AIK certificate (e.g., using a privacy CA in computer system 112); and perform the remote attestation with access point 116-1 based at least in part on the AIK certificate, where the remote attestation includes TPM attestation. (Note that TPM attestation allows a CA to verify that a private key is protected by an instance of a TPM chip and that the instance of the TPM chip is one that the CA trusts. Moreover, endorsement keys that are proven valid may be used to bind a user identity to an electronic device.)

Next, computer system 112 may receive, from access point 116-1, confirmation information (such as the manufacturing certificate and/or the AIK certificate) and may perform a join flow with access point 116-1 based at least in part on the confirmation information, where the join flow establishes a connection between access point 116-1 and computer system 112. Note that the join flow may include performing mutual authentication with access point 116-1, such as by using or performing mTLS. Furthermore, computer system 112 may perform verification of access point 116-1 based at least in part on the identifier and a result of the TPM attestation. When the verification is successful, computer system 112 may provide, to access point 116-1, authorization information (such as a JWT). In some embodiments, computer system 112 may periodically perform the TPM attestation with access point 116-1.

In these ways, the authentication techniques may provide the common remote-attestation procedure that allows computer network devices (which may or may not include instances of the TMP chip) to be securely authenticated and allowed to join the network. Therefore, the authentication techniques may help prevent malicious or rogue computer network devices from joining the network. Consequently, the authentication techniques may enhance security of the network and, thus, may provide an improved user experience.

Moreover, software and/or a configuration file in a computer network device (such as one of access points 116, radio nodes 118 and/or switch 128) may be changed or modified by a malicious actor. Alternatively or additionally, the software and/or the configuration file may be cloned and used in a rogue computer network device.

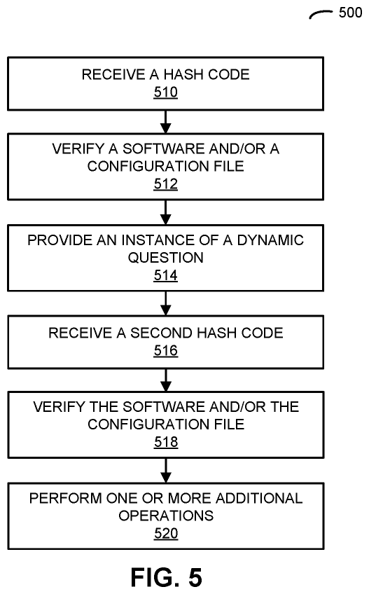

As described below with reference to FIGS. 5-7, in order to address this problem, a computer system (such as computer system 112) may perform verification of the software and/or the configuration file installed on an electronic device (such as access point 116-1). During operation, access point 116-1 may generate and provide a hash code associated with the software and/or the configuration file installed on access point 116-1. For example, access point 116-1 may generate the hash code using a hash function that is installed on access point 116-1 and that is previously agreed to by computer system 112 and/or access point 116-1.

After receiving the hash code, computer system 112 may verify the software and/or the configuration file based at least in part on the hash code. For example, computer system 112 may compare the hash code to a stored hash code in memory in computer system 112 (which may have been generated when the software and/or the configuration file was provided to access point 116-1) or a dynamically generated hash code (which is generated after the hash code is received based at least in part on a stored copy of the software and/or the configuration file in memory in computer system 112, e.g., a software binary file or a compiled software file).

Subsequently, computer system 112 may provide, to access point 116-1, an instance of a dynamic question associated with the software, the configuration file and/or a process executed by access point 116-1. In response to the instance of the dynamic question, access point 116-1 may generate and provide a second hash code to computer system 112. Note that the second hash code may be computed by access point 116-1 at runtime of the software or the process.

Furthermore, after receiving the second hash function, computer system 112 may verify the software and/or the configuration file based at least in part on the second hash code. For example, computer system 112 may compare the hash code to a stored hash code in memory in computer system 112 (which may have been generated previously based at least in part on the correct answer to the instance of the dynamic question using information stored in or available to computer system 112) or a dynamically generated hash code (which is generated after the second hash code is received based at least in part on the correct answer to the instance of the dynamic question using information stored in or available to computer system 112).

Note that the instance of the dynamic question may be provided when computer system 112 perform TPM attestation with access point 116-1. However, in general, access point 116-1 may or may not include an instance of a TPM chip.

Furthermore, instances of the dynamic question may be provided periodically (where, in general, the instances of the dynamic question involve or include different questions). In some embodiments, the instance of the dynamic question is varied as a function of time. For example, the instance of the dynamic question may be randomly selected from a set of predefined questions. Note that the instance of the dynamic question may include: which process uses most resources in access point 116-1, a request for a list of processes executed by access point 116-1, etc.

Additionally, the instance of the dynamic question may include or may specify a hash function that is to be used by access point 116-1 to generate the second hash code. Alternatively or additionally, prior to providing the instance of the dynamic question, computer system 112 may provide, to access point 116-1, the hash function.

In these ways, the verification techniques may ensure that the software and/or the configuration file are unchanged or match a deployed instance of the software and/or the configuration file. This may help prevent stolen or malicious code from being installed and used by computer network devices, such as access point 116-1. Consequently, the verification techniques may enhance security of a network that includes access point 116-1 and, thus, may provide an improved user experience.

In the described embodiments, processing a frame or a packet in a given one of the one or more access points 116 or a given one of the one or more electronic devices 110 may include: receiving wireless signals 126 with the frame or packet; decoding/extracting the frame or packet from the received wireless signals 126 to acquire the frame or packet; and processing the frame or packet to determine information contained in the frame or packet.

Although we describe the network environment shown in FIG. 1 as an example, in alternative embodiments, different numbers or types of electronic devices or components may be present. For example, some embodiments comprise more or fewer electronic devices or components. Therefore, in some embodiments there may be fewer or additional instances of at least some of the one or more access points 116, the one or more electronic devices 110 and/or computer system 112. As another example, in another embodiment, different electronic devices are transmitting and/or receiving frames or packets.

We now describe embodiments of the authentication method. FIG. 2 presents an example of a flow diagram illustrating an example method 200 for performing remote attestation. Moreover, method 200 may be performed by a computer system, such as computer system 112 in FIG. 1.

During operation, when an electronic device includes or does not include an instance of a TPM chip, the computer system performs a set of operations. Notably, the computer system may receive, associated with a second electronic device, provisioning information (operation 210) for the electronic device. Then, the computer system may confirm a license (operation 212) associated with the electronic device based at least in part on the provisioning information. Note that confirming the license may include confirming that the electronic device is associated with a customer.

Moreover, the computer system may receive, associated with the electronic device, confirmation information (operation 220) and may perform a join flow (operation 222) with the electronic device based at least in part on the confirmation information, where the join flow establishes a connection between the electronic device and the computer system. For example, the confirmation information may include a manufacturer certificate. Furthermore, the join flow may include performing mutual authentication with the electronic device. Notably, the mutual authentication may include mTLS.

Next, the computer system may provide, addressed to the electronic device, authorization information (operation 226). For example, the authorization information may include a JSON Web Token (JWT).

In some embodiments, the electronic device includes the instance of the TPM chip. (However, in other embodiments, the electronic device may not include the instance of the TPM chip.) In these embodiments, the provisioning information may include an identifier associated with the instance of the TPM chip in the electronic device. For example, the identifier may include a serial number of the instance of the TPM chip. Moreover, the license may be associated with the instance of the TPM chip. Furthermore, prior to performing the join flow (operation 222), the computer system may optionally: provide, addressed to the electronic device, an AIK (operation 214) certificate; sign the AIK certificate (operation 216); and perform the remote attestation (operation 218) with the electronic device based at least in part on the AIK certificate, where the remote attestation includes TPM attestation. Additionally, the confirmation information may include the AIK certificate. Next, the computer system may optionally perform verification (operation 224) of the electronic device based at least in part on the identifier and a result of the TPM attestation. When the verification is successful (operation 224), the computer system may optionally provide the authorization information (operation 226).

Note that the AIK certificate may be associated with a TPM verifier in the computer system, and the TPM verifier may perform the TPM attestation with a TPM attestor in the electronic device. In some embodiments, the AIK certificate may be signed by a privacy certificate authority (CA) in the computer system.

In some embodiments, the computer system optionally performs one or more additional operations (operation 228). Notably, the computer system may periodically perform the TPM attestation with the electronic device.

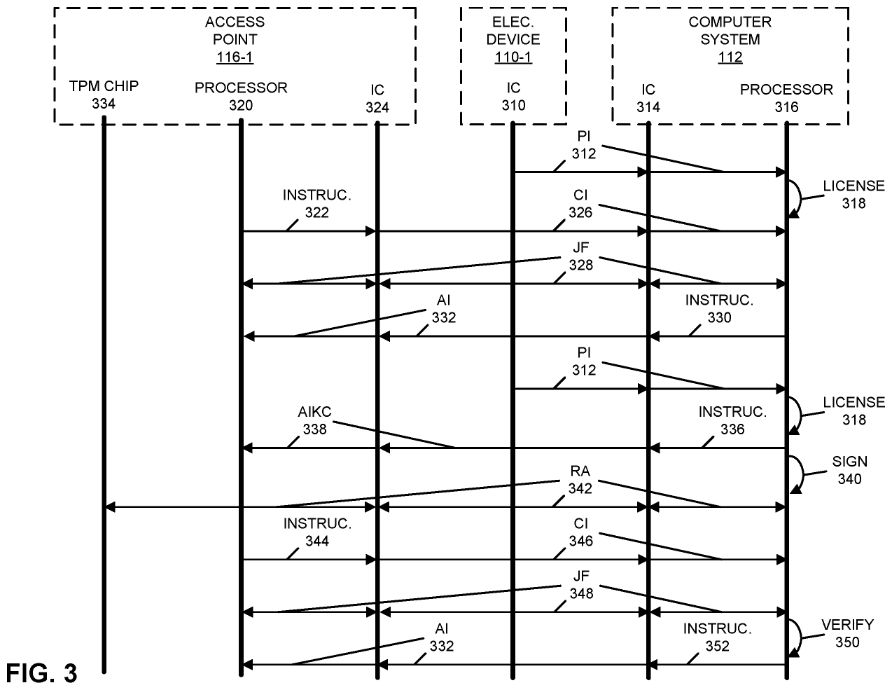

FIG. 3 presents a drawing illustrating an example of communication between electronic device 110-1, access point 116-1 and computer system 112. In FIG. 3, when access point 116-1 does not include an instance of a TPM chip, an interface circuit (IC) 310 in electronic device 110-1 may provide provisioning information (PI) 312 for access point 116-1 to computer system 112. After receiving provisioning information 312, an interface circuit 314 in computer system 112 may provide provisioning information 312 to a processor 316 in computer system 112. Then, processor 316 may confirm a license 318 associated with access point 116-1 based at least in part on provisioning information 312.

Moreover, processor 320 in access point 116-1 may instruct 322 an interface circuit 324 in access point 116-1 to provide confirmation information or CI 326 (such as a manufacturer certification of access point 116-1) to access point 116-1. After receiving confirmation information 326, interface circuit 314 may provide confirmation information 326 to processor 316.

Next, processor 320 in access point 116-1 may, via interface circuit 324 and interface circuit 314, perform a join flow (JF) 328 with processor 316 based at least in part on confirmation information 326, where the join flow establishes a connection between access point 116-1 and computer system 112. Furthermore, processor 316 may instruct 330 interface circuit 314 to provide authorization information (AI) 332 to access point 116-1. After receiving authorization information 332, interface circuit 324 may provide authorization information 332 to processor 320.

Alternatively, when access point 116-1 includes an instance of a TPM chip 334, interface circuit 310 may provide provisioning information 312 to computer system 112. After receiving provisioning information 312, interface circuit 314 may provide provisioning information 312 to processor 316. Then, processor 316 may confirm license 318 associated with access point 116-1 based at least in part on provisioning information 312.

Moreover, processor 316 may instruct 336 interface circuit 314 to provide an AIK certificate (AIKC) 338 to access point 116-1. After receiving AIK certificate 338 interface circuit 324 may provide AIK certificate 338 to processor 320. Next, processor 316 may sign 340 AIK certificate 338, and may perform remote attestation (RA) 342 with the instance of TPM chip 336 in access point 116-1 via interface circuit 314 and interface circuit 324 based at least in part on AIK certificate 338.

Furthermore, processor 320 may instruct 344 interface circuit 324 to provide confirmation information 346 (such as AIK certificate 338) to computer system 112. After receiving confirmation information 346, interface circuit 314 may provide confirmation information 346 to processor 316. Additionally, processor 320 may, via interface circuit 324 and interface circuit 314, perform a join flow (JF) 348 with processor 316 based at least in part on confirmation information 346, where the join flow establishes a connection between access point 116-1 and computer system 112.

Then, processor 318 may perform verification 350 of access point 116-1 based at least in part on an identifier of access point 116-1 (which may be included in provisioning information 312) and a result of remote attestation 342. When verification 350 is successful, processor 316 may instruct 352 interface circuit 314 to provide authorization information 332 to access point 116-1. After receiving authorization information 332, interface circuit 324 may provide authorization information 332 to processor 320.

We now further describe the authentication techniques. Notably, the authentication techniques may dynamically enable TPM capability in electronic devices for enhanced security via TPM attestation. Moreover, this TPM capability may be pluggable, so that, if an electronic device does not include an instance of a TPM chip, the remaining functionality is unaffected when the TPM capability is disabled. The authentication techniques may be enabling for securely executing applications dynamically on edge devices in a network (such as on access points).

As noted previously, TPM is an optional component inside electronic devices. Moreover, in order to enhance security, remote attestation is typically performed before an electronic device is allowed to connect to a network and/or a cloud-based computer system (such as a controller) in a network. From the perspective of the controller, remote attestation (which is sometimes referred to as ‘trusted computing’) may be a pluggable service in order to control the electronic-device lifecycle. The disclosed authentication techniques incorporate remote attestation into originally an onboarding flow. Notably, when a TPM electronic device (or an electronic device that includes an instance of a TPM chip) is joining, a device management service in the computer system may check a remote attestation result. When the device management service receives a remote-attestation failure message after an electronic device has joined a network, the device management service may notify a device lifecycle service in the computer system to kick the TPM electronic device out of the network or discontinuing the connection to the computer system. Alternatively or in addition to an endorsement key (EK) or platform key certificate, the endpoint for a TPM verifier in the computer system may also check a manufacturer certificate or a manufacturer installed certificate, because the computer system may not want to only trust the TPM CA or platform CA in the computer system. After an AIK certificate is issued, all applications in the TPM electronic device may use the AIK certificate as a client certificate (via mTLS) in order to make sure they are running alongside the TPM attestor in the TPM electronic device for trustworthiness. However, when remote-attestation fails, the TPM verifier may invalidate the AIK certificate (in addition to kicking the electronic device out of the network or discontinuing the connection to the computer system).

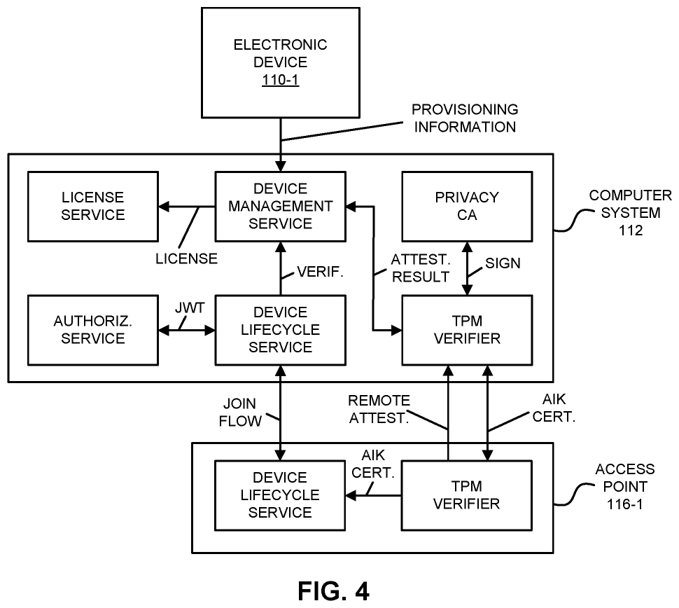

FIG. 4 presents a drawing illustrating an example of communication among access point 116-1 and computer system 112. Notably, during a registration process, an electronic device 110-1 associated with a user (such as a network administrator or operator) may provision a device management service in computer system 112 with provisioning information for the instance of a TPM chip in access point 116-1. Then, during the registration process, the device management service may check a license for access point 116-1 with a license service in computer system 112.

Moreover, when access point 116-1 includes an optional TPM attestor (which may include the instance of the TPM chip), a TPM verifier in computer system 112 may perform AIK certificate enrollment. In some embodiments, the TPM verifier may boot access point 116-1 and/or the optional TPM attestor may generate a private key for access point 116-1.

Next, the TPM verifier may have a privacy CA in computer system 112 sign the AIK certificate by sending a AIK certificate signing request (CSR) to the privacy CA. Furthermore, the TPM attestor may pass the AIK certificate to a registrar agent in access point 116-1. These operations may confirm that access point 116-1 is who it says it is and that it is trustworthy. This authentication and trustworthiness may be confirmed periodically. For example, the TPM attestor may periodically perform remote attestation with the TPM verifier using the AIK certificate. Additionally, the TPM verifier may notify the device management service about the attestation result(s).

The registrar agent may join or connect with the network or computer system 112 via device lifecycle service in computer system 112. When access point 116-1 include the TPM attestor, the registrar agent may join and get approval (such as a JWT that indicates or specifies a scope of service for access point 116-1) from the device lifecycle service using mTLS and the AIK certificate. During the joining, the device lifecycle service may perform device verification with the device management service by performing a check on the attestation result(s), e.g., by having the device management service perform a look up of the attestation result(s) based at least in part on a serial number of access point 116-1. Then, an authorization service in computer system 112 may issue the JWT for access point 116-1 to the device lifecycle service.

Note when access point 116-1 does not include the TPM attestor, the aforementioned operations of the TPM verifier, the TPM attestor and the privacy CA may be excluded without impacting the remaining operations in computer system 112 and access point 116-1. Moreover, instead of using the AIK certificate, a manufacturer certificate (or EK certificate) may be used, e.g., during the join flow operation. In some embodiments, the authentication by computer system 112 and access point 116-1 may be configured to use an instance of a TPM chip or may be configured to not use an instance of the TPM chip. Alternatively, the authentication by computer system 112 and access point 116-1 may dynamically and concurrently support authentication with and without an instance of a TPM chip.

We now describe embodiments of the verification method. FIG. 5 presents an example of a flow diagram illustrating an example method 500 for performing remote software and/or configuration-file verification. Moreover, method 500 may be performed by a computer system, such as computer system 112 in FIG. 1.

During operation, the computer system may receive, associated with an electronic device, a hash code (operation 510) associated with software and/or a configuration file installed on the electronic device. Then, the computer system may verify the software and/or the configuration file (operation 512) based at least in part on the hash code. Moreover, the computer system may provide, to the electronic device, an instance of a dynamic question (operation 514) associated with the software, the configuration file and/or a process executed by the electronic device (such as a virtual machine). Next, the computer system may receive, associated with the electronic device, a second hash code (operation 516) in response to the instance of the dynamic question. Furthermore, the computer system may verify the software and/or the configuration file (operation 518) based at least in part on the second hash code.

In some embodiments, the computer system optionally performs one or more additional operations (operation 520). For example, instances of the dynamic question may be provided periodically.

Note that the instance of the dynamic question may be provided when the computer system performs TPM attestation with the electronic device. However, in general, the electronic device may or may not include an instance of a TPM chip.

Moreover, the software may include a software binary.

Furthermore, the instance of the dynamic question may be varied as a function of time. For example, the instance of the dynamic question may be randomly selected from a set of predefined questions.

Additionally, the second hash code may be computed by the electronic device at runtime of the software or the process.

Moreover, the instance of the dynamic question may include or may specify a hash function (such as SHA 256) that is to be used by the electronic device to generate the second hash code. Alternatively or additionally, prior to providing the instance of the dynamic question (operation 514), the computer system may provide, addressed to the electronic device, the hash function.

In some embodiments, the configuration file may include an Internet Protocol (IP) table.

Furthermore, the instance of the dynamic question may include: which process uses most resources in the electronic device, a request for a list of processes executed by the electronic device (which may be known to a manufacturer of the electronic device or an operator of the computer system), etc. For example, the electronic device may trigger system code, so that an operating system in the electronic device provides the list or processes currently executed by the electronic device.

In some embodiments of methods 200 (FIG. 2) and/or 500, there may be additional or fewer operations. Moreover, there may be different operations. Furthermore, the order of the operations may be changed, and/or two or more operations may be combined into a single operation.

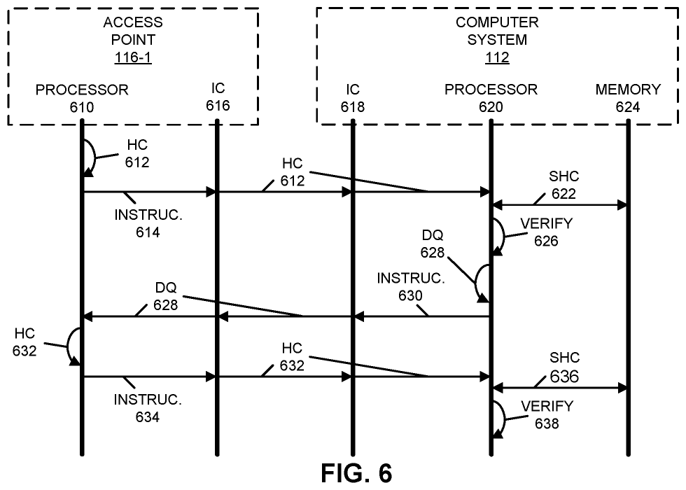

FIG. 6 presents a drawing illustrating an example of communication between access point 116-1 and computer system 112. In FIG. 6, a processor 610 in access point 116-1 select or generate a hash code (HC) 612 associated with the software and/or the configuration file installed on access point 116-1. Then, processor 610 may instruct 614 an interface circuit 616 in access point 116-1 to provide hash code 612 to computer system 112.

After receiving hash code 612, an interface circuit 618 in computer system 112 may provide hash code 612 to a processor 620 in computer system 112. Processor 620 may verify 626 hash code 612 by comparing hash code 612 to a stored hash code (SHC) 622 in memory 624 in computer system 112.

Subsequently, processor 620 may select or generate an instance of a dynamic question (DQ) 628, and may instruct 630 interface circuit 618 to provide the instance of dynamic question 628 to access point 116-1. After receiving the instance of dynamic question 628, interface circuit 616 may provide the instance of dynamic question 628 to processor 610.

In response to the instance of dynamic question 628, processor 610 may select or generate hash code 632. Next, processor 610 may instruct 634 interface circuit 616 to provide hash code 632 to computer system 112.

After receiving hash code 632, interface circuit 618 may provide hash code 632 to processor 620. Processor 620 may verify 638 hash code 632 by comparing hash code 632 to a stored hash code 636 in memory 624.

While FIGS. 3 and 6 illustrate some operations using unilateral or bilateral communication (which are, respectively, represented by one-sided and two-sided arrows), in general a given operation in FIGS. 3 and 6 may involve unilateral or bilateral communication. Moreover, while FIGS. 3 and 6 illustrate operations being performed sequentially or at different times, in other embodiments at least some of these operations may, at least in part, be performed concurrently or in parallel.

We now further describe the verification techniques. Notably, because of chip shortages and the availability of virtual machine (VM)-based solutions, some electronic devices do not include instance of a TPM chip or module. For example, some certain access points, virtual data planes, virtual edge device and/or virtual controllers do not include instances of a TMP chip. However, even when this occurs, it may not be possible to prevent theft of a private key (which may be protected by an instance of a TPM chip). Moreover, it can be difficult to prevent cloning of a VM or software associated with a customer. In order to address these problems with or without an instance of a TPM chip in a computer network device, the verification techniques may be used to detect when a private key is stolen or cloned as soon as possible (e.g., as part of a remote-attestation operation).

In particular, the verification techniques may be used to ensure that binary or binary code (such as software or program instructions) and/or a configuration file are not compromised. For example, the verification techniques may be used to protect an attestor or an IP table. Moreover, the verification techniques may protect the software and/or the configuration file by ensuring that expected behavior has not been changed. When a change is detected, the software and/or the configuration file may no longer pass remote attestation.

In some embodiments, a computer system may provide dynamic questions to an electronic device (such as an access point) for each remote attestation. Note that the hash code for remote attestation may be more complicated. This may ensure that it is hard to compromise the attestor.

Using the verification techniques, all a malicious hacker can do is clone the software in the whole electronic device. However, the verification techniques may be used to detect when there is duplicated behavior with the same private key in a certain time window or time interval. When a verifier in the computer system determines that there is a duplicated request sent to it, the verifier may conclude that the private key has been cloned.

Note that the verification techniques may not be able to detect code that is directly injected into a process directly, such Log4Shell or Spring4Shell. This is because this kind of code injection does not need to change files.

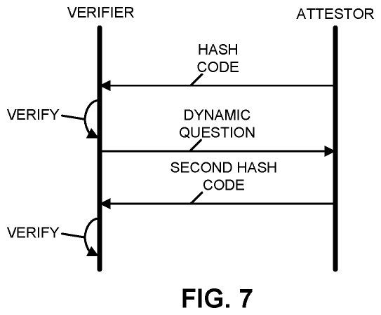

FIG. 7 presents a flow diagram illustrating an example method 700 for performing remote software and/or configuration-file verification using computer system 112. Notably, an attestor in access point 116-1 may provide a hash code corresponding to a binary (or software) and/or configuration file(s) to a verifier in computer system 112. After receiving the hash code, the verifier may verify the hash code. For example, the verifier may compare the hash code to a stored hash code or may dynamically generate the hash code, such as based at least in part on a known file size of the binary. In addition, the verifier may confirm that the hash code is associated with the physical layer serial number of the binary and/or the configuration file(s).

Subsequently (e.g., periodically), the verifier may provide dynamic question(s) to the attestor for random binary and/or configuration file(s) or a running processor list. For example, if there are 10 binary files installed on access point 116-1, at a given time, computer system 112 may select one of the 10 binary files (such as randomly) and may provide a dynamical question associated with the selected binary file. Because there may be up to 2¹⁰ combinations of dynamic questions, it may be difficult for a malicious entity to defeat the verification techniques. In response, the attestor may provide a second hash code to the verifier based at least in part on the dynamic question(s). Then, the verifier may verify the second hash code.

We now describe embodiments of an electronic device, which may perform at least some of the operations in the authentication and the verification techniques. FIG. 8 presents a block diagram illustrating an example of an electronic device 800 in accordance with some embodiments, such as one of: base station 108, one of electronic devices 110, computer system 112, one of access points 116, one of radio nodes 118, and/or switch 128. This electronic device includes processing subsystem 810, memory subsystem 812, and networking subsystem 814. Processing subsystem 810 includes one or more devices configured to perform computational operations. For example, processing subsystem 810 can include one or more microprocessors, ASICs, microcontrollers, programmable-logic devices, graphical processor units (GPUs) and/or one or more digital signal processors (DSPs).

Memory subsystem 812 includes one or more devices for storing data and/or instructions for processing subsystem 810 and networking subsystem 814. For example, memory subsystem 812 can include dynamic random access memory (DRAM), static random access memory (SRAM), and/or other types of memory (which collectively or individually are sometimes referred to as a ‘computer-readable storage medium’). In some embodiments, instructions for processing subsystem 810 in memory subsystem 812 include: one or more program modules or sets of instructions (such as program instructions 822 or operating system 824), which may be executed by processing subsystem 810. Note that the one or more computer programs may constitute a computer-program mechanism. Moreover, instructions in the various modules in memory subsystem 812 may be implemented in: a high-level procedural language, an object-oriented programming language, and/or in an assembly or machine language. Furthermore, the programming language may be compiled or interpreted, e.g., configurable or configured (which may be used interchangeably in this discussion), to be executed by processing subsystem 810.

In addition, memory subsystem 812 can include mechanisms for controlling access to the memory. In some embodiments, memory subsystem 812 includes a memory hierarchy that comprises one or more caches coupled to a memory in electronic device 800. In some of these embodiments, one or more of the caches is located in processing subsystem 810.

In some embodiments, memory subsystem 812 is coupled to one or more high-capacity mass-storage devices (not shown). For example, memory subsystem 812 can be coupled to a magnetic or optical drive, a solid-state drive, or another type of mass-storage device. In these embodiments, memory subsystem 812 can be used by electronic device 800 as fast-access storage for often-used data, while the mass-storage device is used to store less frequently used data.

Networking subsystem 814 includes one or more devices configured to couple to and communicate on a wired and/or wireless network (i.e., to perform network operations), including: control logic 816, an interface circuit 818 and one or more antennas 820 (or antenna elements). (While FIG. 8 includes one or more antennas 820, in some embodiments electronic device 800 includes one or more nodes, such as nodes 808, e.g., an antenna node, a connector or a pad, which can be coupled to the one or more antennas 820. Thus, electronic device 800 may or may not include the one or more antennas 820.) For example, networking subsystem 814 can include a Bluetooth networking system, a cellular networking system (e.g., a 3G/4G/5G network such as UMTS, LTE, etc.), a USB networking system, a networking system based on the standards described in IEEE 802.11 (e.g., a Wi-Fi networking system), an Ethernet networking system, and/or another networking system.

In some embodiments, a transmit antenna radiation pattern of electronic device 800 may be adapted or changed using pattern shapers (such as reflectors) in one or more antennas 820 (or antenna elements), which can be independently and selectively electrically coupled to ground to steer the transmit antenna radiation pattern in different directions. Thus, if one or more antennas 820 includes N antenna-radiation-pattern shapers, the one or more antennas 820 may have 2^{N} different antenna-radiation-pattern configurations. More generally, a given antenna radiation pattern may include amplitudes and/or phases of signals that specify a direction of the main or primary lobe of the given antenna radiation pattern, as well as so-called ‘exclusion regions’ or ‘exclusion zones’ (which are sometimes referred to as ‘notches’ or ‘nulls’). Note that an exclusion zone of the given antenna radiation pattern includes a low-intensity region of the given antenna radiation pattern. While the intensity is not necessarily zero in the exclusion zone, it may be below a threshold, such as 3 dB or lower than the peak gain of the given antenna radiation pattern. Thus, the given antenna radiation pattern may include a local maximum (e.g., a primary beam) that directs gain in the direction of an electronic device that is of interest, and one or more local minima that reduce gain in the direction of other electronic devices that are not of interest. In this way, the given antenna radiation pattern may be selected so that communication that is undesirable (such as with the other electronic devices) is avoided to reduce or eliminate adverse effects, such as interference or crosstalk.

Networking subsystem 814 includes processors, controllers, radios/antennas, sockets/plugs, and/or other devices used for coupling to, communicating on, and handling data and events for each supported networking system. Note that mechanisms used for coupling to, communicating on, and handling data and events on the network for each network system are sometimes collectively referred to as a ‘network interface’ for the network system. Moreover, in some embodiments a ‘network’ or a ‘connection’ between the electronic devices does not yet exist. Therefore, electronic device 800 may use the mechanisms in networking subsystem 814 for performing simple wireless communication between the electronic devices, e.g., transmitting frames and/or scanning for frames transmitted by other electronic devices.

Within electronic device 800, processing subsystem 810, memory subsystem 812, and networking subsystem 814 are coupled together using bus 828. Bus 828 may include an electrical, optical, and/or electro-optical connection that the subsystems can use to communicate commands and data among one another. Although only one bus 828 is shown for clarity, different embodiments can include a different number or configuration of electrical, optical, and/or electro-optical connections among the subsystems.

In some embodiments, electronic device 800 includes a display subsystem 826 for displaying information on a display, which may include a display driver and the display, such as a liquid-crystal display, a multi-touch touchscreen, etc.

Electronic device 800 can be (or can be included in) any electronic device with at least one network interface. For example, electronic device 800 can be (or can be included in): a desktop computer, a laptop computer, a subnotebook/netbook, a server, a computer, a mainframe computer, a cloud-based computer, a tablet computer, a smartphone, a cellular telephone, a smartwatch, a wearable device, a consumer-electronic device, a portable computing device, an access point, a transceiver, a controller, a radio node, a router, a switch, communication equipment, a wireless dongle, test equipment, and/or another electronic device.

Although specific components are used to describe electronic device 800, in alternative embodiments, different components and/or subsystems may be present in electronic device 800. For example, electronic device 800 may include one or more additional processing subsystems, memory subsystems, networking subsystems, and/or display subsystems. Additionally, one or more of the subsystems may not be present in electronic device 800. Moreover, in some embodiments, electronic device 800 may include one or more additional subsystems that are not shown in FIG. 8. Also, although separate subsystems are shown in FIG. 8, in some embodiments some or all of a given subsystem or component can be integrated into one or more of the other subsystems or component(s) in electronic device 800. For example, in some embodiments program instructions 822 are included in operating system 824 and/or control logic 816 is included in interface circuit 818.

Moreover, the circuits and components in electronic device 800 may be implemented using any combination of analog and/or digital circuitry, including: bipolar, PMOS and/or NMOS gates or transistors. Furthermore, signals in these embodiments may include digital signals that have approximately discrete values and/or analog signals that have continuous values. Additionally, components and circuits may be single-ended or differential, and power supplies may be unipolar or bipolar.

An integrated circuit (which is sometimes referred to as a ‘communication circuit’ or a ‘means for communication’) may implement some or all of the functionality of networking subsystem 814. The integrated circuit may include hardware and/or software mechanisms that are used for transmitting wireless signals from electronic device 800 and receiving signals at electronic device 800 from other electronic devices. Aside from the mechanisms herein described, radios are generally known in the art and hence are not described in detail. In general, networking subsystem 814 and/or the integrated circuit can include any number of radios. Note that the radios in multiple-radio embodiments function in a similar way to the described single-radio embodiments.

In some embodiments, networking subsystem 814 and/or the integrated circuit include a configuration mechanism (such as one or more hardware and/or software mechanisms) that configures the radio(s) to transmit and/or receive on a given communication channel (e.g., a given carrier frequency). For example, in some embodiments, the configuration mechanism can be used to switch the radio from monitoring and/or transmitting on a given communication channel to monitoring and/or transmitting on a different communication channel. (Note that ‘monitoring’ as used herein comprises receiving signals from other electronic devices and possibly performing one or more processing operations on the received signals)

In some embodiments, an output of a process for designing the integrated circuit, or a portion of the integrated circuit, which includes one or more of the circuits described herein may be a computer-readable medium such as, for example, a magnetic tape or an optical or magnetic disk. The computer-readable medium may be encoded with data structures or other information describing circuitry that may be physically instantiated as the integrated circuit or the portion of the integrated circuit. Although various formats may be used for such encoding, these data structures are commonly written in: Caltech Intermediate Format (CIF), Calma GDS II Stream Format (GDSII), Electronic Design Interchange Format (EDIF), OpenAccess (OA), or Open Artwork System Interchange Standard (OASIS). Those of skill in the art of integrated circuit design can develop such data structures from schematics of the type detailed above and the corresponding descriptions and encode the data structures on the computer-readable medium. Those of skill in the art of integrated circuit fabrication can use such encoded data to fabricate integrated circuits that include one or more of the circuits described herein.

While the preceding discussion used Wi-Fi and/or Ethernet communication protocols as illustrative examples, in other embodiments a wide variety of communication protocols and, more generally, communication techniques may be used. Thus, the authentication and/or the verification techniques may be used in a variety of network interfaces. Furthermore, while some of the operations in the preceding embodiments were implemented in hardware or software, in general the operations in the preceding embodiments can be implemented in a wide variety of configurations and architectures. Therefore, some or all of the operations in the preceding embodiments may be performed in hardware, in software or both. For example, at least some of the operations in the authentication and/or the verification techniques may be implemented using program instructions 822, operating system 824 (such as a driver for interface circuit 818) or in firmware in interface circuit 818. Alternatively or additionally, at least some of the operations in the authentication and the verification techniques may be implemented in a physical layer, such as hardware in interface circuit 818.

Additionally, while the preceding embodiments illustrated the use of wireless signals in one or more bands of frequencies, in other embodiments of these signals may be communicated in one or more bands of frequencies, including: a microwave frequency band, a radar frequency band, 900 MHz, 2.4 GHz, 5 GHz, 6 GHz, 7 GHz, 60 GHz, and/or a band of frequencies used by a Citizens Broadband Radio Service or by LTE. In some embodiments, the communication between electronic devices uses multi-user transmission (such as OFDMA).

In the preceding description, we refer to ‘some embodiments.’ Note that ‘some embodiments’ describes a subset of all of the possible embodiments, but does not always specify the same subset of embodiments. Moreover, note that numerical values in the preceding embodiments are illustrative examples of some embodiments. In other embodiments of the authentication and/or the verification techniques, different numerical values may be used.

The foregoing description is intended to enable any person skilled in the art to make and use the disclosure, and is provided in the context of a particular application and its requirements. Moreover, the foregoing descriptions of embodiments of the present disclosure have been presented for purposes of illustration and description only. They are not intended to be exhaustive or to limit the present disclosure to the forms disclosed. Accordingly, many modifications and variations will be apparent to practitioners skilled in the art, and the general principles defined herein may be applied to other embodiments and applications without departing from the spirit and scope of the present disclosure. Additionally, the discussion of the preceding embodiments is not intended to limit the present disclosure. Thus, the present disclosure is not intended to be limited to the embodiments shown, but is to be accorded the widest scope consistent with the principles and features disclosed herein.

1. A computer system, comprising:
an interface circuit configured to communicate with an electronic device;
a processor; and
memory that stores program instructions, wherein, when executed by the processor, the program instructions cause the computer system to perform, when the electronic device comprises or does not comprise an instance of a trusted platform module (TPM) chip, operations comprising:
receiving, associated with a second electronic device, provisioning information for the electronic device;
confirming a license associated with the electronic device based at least in part on the provisioning information;
receiving, associated with the electronic device, confirmation information;
performing a join flow with the electronic device based at least in part on the confirmation information, wherein the join flow establishes a connection between the electronic device and the computer system; and
providing, addressed to the electronic device, authorization information.

2. The computer system of claim 1, wherein confirming the license comprising confirming that the electronic device is associated with a customer.

3. The computer system of claim 1, wherein the join flow comprises performing mutual authentication with the electronic device.

4. The computer system of claim 1, wherein the confirmation information comprises a manufacturer certificate.

5. The computer system of claim 1, wherein the authorization information comprises a JavaScript Object Notation (JSON) Web Token (JWT).

6. The computer system of claim 1, wherein the electronic device comprises the instance of the TPM chip.

7. The computer system of claim 6, wherein the provisioning information comprises an identifier associated with the instance of the TPM chip in the electronic device.

8. The computer system of claim 7, wherein the identifier comprises a serial number of the instance of the TPM chip.

9. The computer system of claim 6, wherein the license is associated with the instance of the TPM chip.

10. The computer system of claim 6, wherein, prior to performing the join flow, the operations comprise:
providing, addressed to the electronic device, an attestor identity key (AIK) certificate;
signing the AIK certificate; and
performing remote attestation with the electronic device based at least in part on the AIK certificate, wherein the remote attestation comprises TPM attestation.

11. The computer system of claim 10, wherein the confirmation information comprises the AIK certificate.

12. The computer system of claim 11, wherein the operations comprise performing verification of the electronic device based at least in part on the identifier and a result of the TPM attestation; and
wherein the authorization information is provided when the verification is successful.

13. The computer system of claim 10, wherein the AIK certificate is associated with a TPM verifier in the computer system, and the TPM verifier performs the TPM attestation with a TPM attestor in the electronic device.

14. The computer system of claim 10, wherein the AIK certificate is signed by a privacy certificate authority (CA) in the computer system.

15. The computer system of claim 10, wherein the operations comprise periodically performing the TPM attestation with the electronic device.

16. A non-transitory computer-readable storage medium for use in conjunction with a computer system, the computer-readable storage medium storing program instructions, wherein, when executed by the computer system, the program instructions cause the computer system to perform, when an electronic device comprises or does not comprise an instance of a trusted platform module (TPM) chip, operations comprising:
receiving, associated with a second electronic device, provisioning information for the electronic device;
confirming a license associated with the electronic device based at least in part on the provisioning information;
receiving, associated with the electronic device, confirmation information;
performing a join flow with the electronic device based at least in part on the confirmation information, wherein the join flow establishes a connection between the electronic device and the computer system; and
providing, addressed to the electronic device, authorization information.

17. The non-transitory computer-readable storage medium of claim 16, wherein the electronic device comprises the instance of the TPM chip; and wherein, prior to performing the join flow, the operations comprise:
providing, addressed to the electronic device, an attestor identity key (AIK) certificate;
signing the AIK certificate; and
performing remote attestation with the electronic device based at least in part on the AIK certificate, wherein the remote attestation comprises TPM attestation.

18. A method for performing remote attestation, comprising:
by a computer system, when an electronic device comprises or does not comprise an instance of a trusted platform module (TPM) chip:
receiving, associated with a second electronic device, provisioning information for the electronic device;
confirming a license associated with the electronic device based at least in part on the provisioning information;
receiving, associated with the electronic device, confirmation information;
performing a join flow with the electronic device based at least in part on the confirmation information, wherein the join flow establishes a connection between the electronic device and the computer system; and
providing, addressed to the electronic device, authorization information.

19. The method of claim 18, wherein the electronic device comprises the instance of the TPM chip; and
wherein, prior to performing the join flow, the method comprises:
providing, addressed to the electronic device, an attestor identity key (AIK) certificate;
signing the AIK certificate; and
performing the remote attestation with the electronic device based at least in part on the AIK certificate, wherein the remote attestation comprises TPM attestation.

20. The method of claim 19, wherein the method comprises performing verification of the electronic device based at least in part on the identifier and a result of the TPM attestation; and
wherein the authorization information is provided when the verification is successful.
